(19) United States
(12) Patent Application Publication
(10) Pub. No.: US 2018/0321551 A1
(43) Pub. Date: Nov. 8, 2018

(54) LIQUID CRYSTAL DISPLAY DEVICE

(71) Applicants: Polatechno Co., Ltd., Niigata (JP); TOHOKU UNIVERSITY, Miyagi (JP)

(72) Inventors: Norio KOMA, Niigata (JP); Daichi FUJIWARA, Niigata (JP); Takahiro ISHINABE, Miyagi (JP); Hideo FUJIKAKE, Miyagi (JP)

(21) Appl. No.: 15/772,264

(22) PCT Filed: Oct. 27, 2016
(86) PCT No.: PCT/JP2016/081802

§ 371 Date: Apr. 30, 2018

(30) Foreign Application Priority Data
Nov. 4, 2015 (JP) 2015-216828

(51) Int. Cl. G02F 1/1335; G02F 1/1333; G02F 1/1343; G02F 1/1337; G02B 5/30

(52) U.S. Cl. CPC G02F 1/133528; G02F 1/133305; G02F 2202/04; G02F 1/133723; G02B 5/305; G02F 1/134309

(57) ABSTRACT

A flexible liquid crystal display device which is obtained by sandwiching a liquid crystal layer between a first substrate and a second substrate, and wherein: the liquid crystal layer-side surface of at least one of the first substrate and the second substrate is provided with a first polarizing film and a second polarizing film; and the first polarizing film and the second polarizing film contain a dye-based polarizing material.

### TECHNICAL FIELD

The present disclosure relates to a liquid crystal display.

### BACKGROUND

Recently, for realization of electronic paper or the like, flexible liquid crystal displays formed using a flexible substrate such as plastic are being developed.

As shown in FIG. 4, a flexible liquid crystal display has a structure in which polarization plates 12a and 12b are formed on a surface on one side of each of resin substrates 10a and 10b such as plastic, transparent electrodes 14a and 14b, and orientation films 16a and 16b are respectively formed on a surface on the opposite side, and a liquid crystal layer 18 is sandwiched between the orientation films 16ta and 16b.

### SUMMARY

### Technical Problem

When the flexible liquid crystal display as shown in FIG. 4 is bent, a phase difference is caused in light transmitting through the resin substrates 10a and 10b such as plastic, which causes a difference in brightness/darkness within a plane, and consequently, degradation of the quality of the display.

In consideration of the above, an advantage of the present disclosure lies in provision of a flexible liquid crystal display in which the quality of display is improved.

### Solution to Problem

According to one aspect of the present disclosure, there is provided a liquid crystal display in which a liquid crystal layer is sandwiched between two substrates, wherein a polarization layer is formed on the side of the liquid crystal layer of at least one substrate of the substrates, and the polarization layer includes a dye-based polarization material.

### Advantageous Effects of Invention

According to the present disclosure, a flexible liquid crystal display having an improved display quality can be provided. In particular, there can be prevented degradation of display quality due to birefringence of the substrate when a plastic substrate or the like is use.

### BRIEF DESCRIPTION OF DRAWINGS

FIG. 1 is a diagram showing a structure of a flexible liquid crystal display according to an embodiment of the present disclosure.

FIG. 2 is a plan view of the flexible liquid crystal display according to the embodiment of the present disclosure.

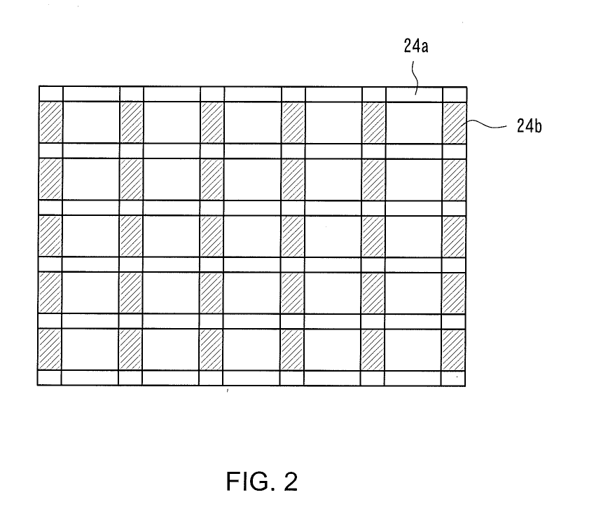

FIG. 3 is a diagram for explaining an operation of the flexible liquid crystal display according to the embodiment of the present disclosure.

FIG. 4 is a diagram showing a structure of a liquid crystal display of the related art.

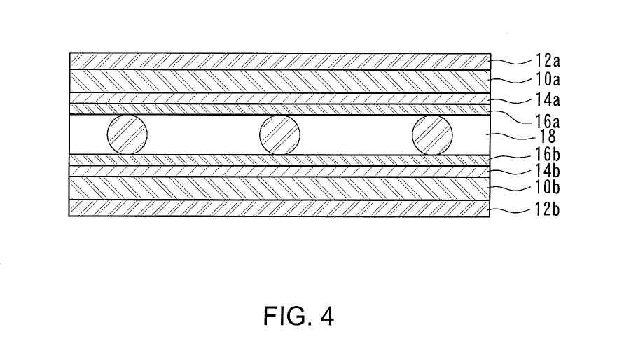

### DESCRIPTION OF EMBODIMENTS

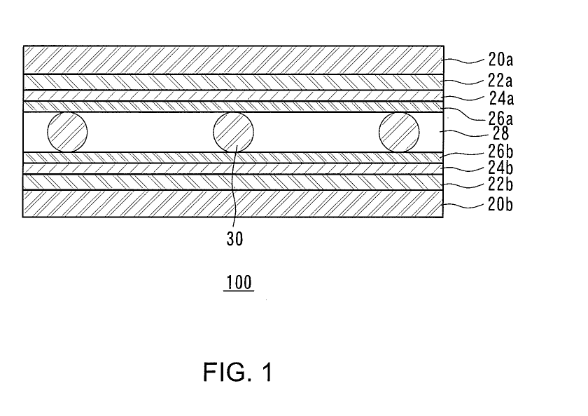

As shown in FIG. 1, a flexible liquid crystal display 100 according to an embodiment of the present disclosure comprises a first substrate 20a, a second substrate 20b, a first polarization film 22a, a second polarization film 22b, a first electrode layer 24a, a second electrode layer 24b, a first orientation film 26a, a second orientation film 26b, and a liquid crystal layer 28.

In the present embodiment, a passive matrix type liquid crystal display is exemplified as the flexible liquid crystal display 100, but the present disclosure is not limited to such a structure, and may alternatively be applied to other forms of liquid crystal display such as an active matrix type liquid crystal display. As for the mode of the liquid crystal display, the present disclosure may be applied to any of a transmissive type, a transflective type, and a reflective type.

The first substrate 20a is a flexible substrate having flexibility. The first substrate 20a is desirably a resin substrate made of a material such as a PET (polyethylene terephthalate) resin, a PES (polyether sulfone) resin, a PEN (polyethylene naphthalate) resin, an epoxy resin, a polyimide resin, an acrylic resin, a polycarbonate resin, or a fiber-reinforced plastic, but may alternatively be a glass substrate. In particular, using the PET resin has an advantage that display can be manufactured inexpensively.

The first polarization film 22a is formed over one surface of the first substrate 20a. The first polarization film 22a is desirably formed from a dye-based material. More desirably, the dye-based material is a dichromatic dye. Here, the dye-based material desirably contains an azo compound and/or a salt of the azo compound.

More specifically, it is desirable to use a dye-based material satisfying the following chemical formula.

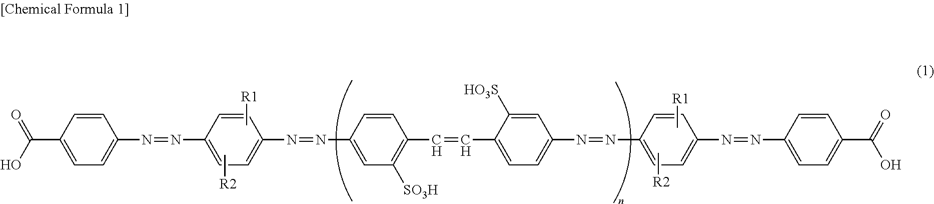

That is, the dye-based material may be: (1) an azo compound or a salt thereof in which, in the Formula, each of R1 and R2 is independently a hydrogen atom, a lower alkyl group, or a lower alkoxyl group, and n is 1 or 2; (2) an azo compound or a salt thereof described in (1) in which each of R1 and R2 is independently one of a hydrogen atom, a methyl group, and a methoxy group; or (3) an azo compound or a salt thereof described in (1) in which R1 and R2 are hydrogen atoms.

For example, a material obtained by the following process is desirable. 13.7 parts of 4-aminobenzoic acid is added to 500 parts of water, and dissolved by sodium hydroxide. The obtained substance is cooled, 32 parts of 35% hydrochloric acid is added at a temperature lower than or equal to 10° C., 6.9 parts of sodium sulfite is then added, and the product is stirred for 1 hour at a temperature of 5-10° C. 20.9 parts of aniline-w-sodium methanesulfonic acid is added, and while stirring at a temperature of 20-30° C., sodium carbonate is added to adjust the pH to 3.5. The product is further stirred to complete a coupling reaction, and filtered, to obtain a monoazo compound. The obtained monoazo compound is stirred at a temperature of 90° C. under presence of sodium hydroxide, to obtain 17 parts of a monoazo compound of Chemical Formula (2).

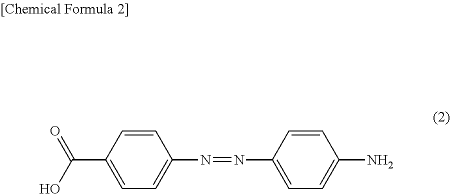 [SMILES: Nc1ccc(N=Nc2ccc(C(=O)O)cc2)cc1]

After 12 parts of the monoazo compound of Chemical Formula (2) and 21 parts of 4,4′-dinitrostilbene-2,2′-sulfonic acid are dissolved in 300 parts of water, 12 parts of sodium hydroxide is added, and a condensation reaction is caused at a temperature of 90° C. Then, after the product is reduced with 9 parts of glucose, and salted out by sodium chloride, the product is filtered, to obtain 16 parts of an azo compound represented by Chemical Formula (3).

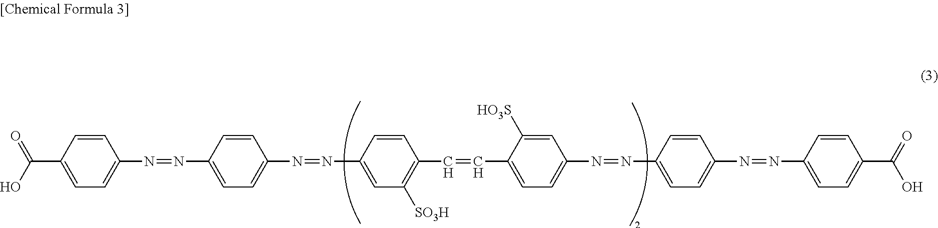

Further, polyvinyl alcohol (PVA) having a thickness of 75 μm is immersed for 4 minutes as the first substrate 20a in an aqueous solution of 45° C. and having concentrations of 0.01% of the dye of Chemical Formula (3), 0.01% of C.I. Direct Red 81, 0.03% of a dye shown in Example 1 of JP 2622748 B and represented by the following Chemical Formula (4), 0.03% of a dye shown in Example 23 of JP S60-156759 A and represented by the following Chemical Formula (5), and 0.1% of Glauber's salt. The film is stretched to a 5-times length at 50° C. in an aqueous solution of 3% boric acid, and is washed by water and dried while maintaining a tensioned state. With this process, a dye-based material having a neutral color (gray in a parallel orientation, and black in a perpendicular orientation) can be obtained.

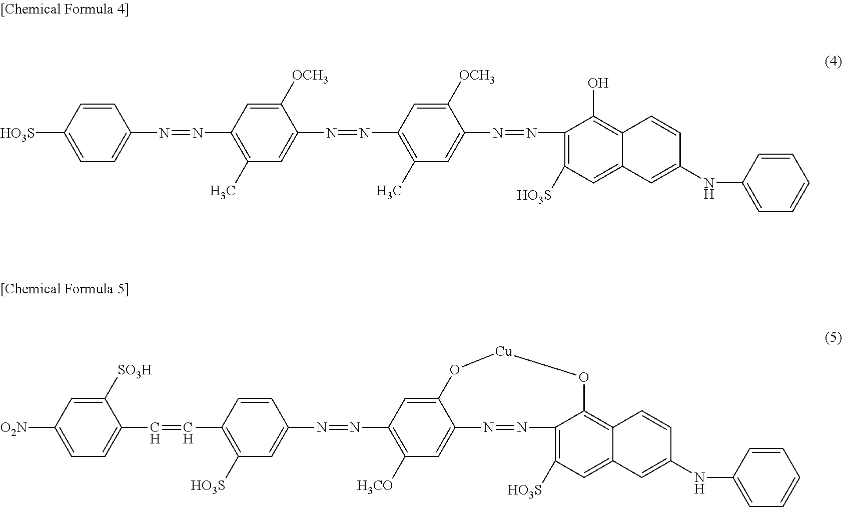

The first electrode layer 24a is formed from a transparent conductive oxide (TCO) such as ITO or ZnO, or a transparent organic conductor such as PEDOT. The first electrode layer 24a is formed over the first polarization film 22a formed over the surface of the first substrate 20a. The first electrode layer 24a may be formed at a film formation temperature of lower than or equal to 40° C. by low-temperature vapor deposition. A resistance value of the first electrode layer 24a is desirably greater than or equal to 80Ω/□ and lower than or equal to 150Ω/□. In the passive matrix type, the first electrode layer 24a is formed in a line shape at positions corresponding to the pixels.

The first orientation film 26a is formed from a resin material such as polyimide. The first orientation film 26a may be formed, for example, by printing a solution of 5 wt % N-methyl-2-pyrrolidinone which becomes a polyimide resin over the first electrode layer 24a, curing by heating at a temperature of about 100° C. to about 200° C., and rubbing with a rubbing cloth to apply an orientation process. Alternatively, a light orientation film may be applied and baked, and polarization ultraviolet rays may be irradiated to achieve the light orientation.

The second substrate 20b, the second polarization film 22b, the second electrode layer 24b, and the second orientation film 26b can be formed by methods approximately similar to those for the first substrate 20a, the first polarization film 22a, the first electrode layer 24a, and the first orientation film 26a, respectively, but alternatively, the second electrode layer 24b may be a reflective electrode made of a metal.

The second substrate 20b is a flexible substrate having a flexibility. The second substrate 20b is desirably a resin substrate made of a material such as the PET (polyethylene terephthalate) resin, the PES (polyether sulfone) resin, the PEN (polyethylene naphthalate) resin, the epoxy resin, the polyimide resin, the acrylic resin, the polycarbonate resin, and the fiber-reinforced plastic, but may alternatively be a glass substrate.

The second polarization film 22b is formed over one surface of the second substrate 20b. The second polarization film 26b is desirably formed from a dye-based material. The dye-based material is more desirably a dichroic dye. For the second polarization film 22b, the dye-based materials exemplified as desirable for the first polarization film 22a are desirably used. For example, polyvinyl alcohol (PVA) is used as the second substrate 20b, and the polyvinyl alcohol is stretched in a solution of the dye-based material, to adsorb and orient the dye-based material. A polarization axis of the second polarization film 22b is set at a direction orthogonal to a polarization axis of the first polarization film 22a.

The second electrode layer 24b is formed from the transparent conductive oxide (TCO) such as ITO and ZnO, or the transparent organic conductor such as PEDOT. The second electrode layer 24b is formed over the second polarization film 22b formed over the surface of the second substrate 20b. The second electrode layer 24b may be formed at a film formation temperature lower than or equal to 40° C. by a low-temperature vapor deposition. The resistance value of the second electrode layer 24b is desirably greater than or equal to 80Ω/□ and lower than or equal to 150Ω/□. In the passive matrix type, the second electrode layer 24b is formed in a line shape at positions corresponding to the pixels and in a direction intersecting the first electrode layer 24a which opposes the second electrode layer 24b.

The second orientation film 26b is formed from the resin material such as polyimide. The second orientation film 26b may be formed, for example, by printing a solution of 5 wt % N-methyl-2-pyrroldinone which becomes polyimide resin over the second electrode layer 24b, curing by heating at a temperature from about 100° C. to about 200° C., and rubbing with a rubbing cloth to apply the orientation process. Alternatively, an orientation film may be applied and baked, and polarization ultraviolet ray may be irradiated, to achieve the light orientation. In the case of a TN-type device, in general, the orientation direction of the second orientation film 26b is set to be orthogonal to the orientation direction of the first orientation film 26a.

Here, when an iodine-based polarization film is applied, with heating at a temperature of greater than or equal to 90° C., a color change occurs on the polarization film, and transmissivity of light is reduced. In contrast, in the present embodiment, because the dye-based material is used for the first polarization film 22a and the second polarization film 22b, even when the curing process of the first orientation film 26a and the second orientation film 26b are executed at a temperature greater than or equal to 90° C., the colors of the first polarization film 22a and the second polarization film 22b do not change, and high light transmissivity can be maintained.

The first orientation film 26a formed over the first substrate 20a and the second orientation film 26b formed over the second substrate 20b are positioned to face each other, a spacer 30 is inserted, liquid crystal is filled between the first orientation film 26a and the second orientation film 26b, and a periphery of the first substrate 20a and the second substrate 20b is sealed by a sealing member (not shown), to form the liquid crystal layer 28. Here, normally, a spherical resin having a predetermined particle size is used for the spacer 30, but more desirably, the spacer 30 is a spacer with stickiness and adhesives. Further alternatively, a column-shaped spacer formed by a photolithography process may be applied.

The flexible liquid crystal display 100 is formed in the process as described above. The flexible liquid crystal display 100 can be bent along an in-plane direction by applying a flexible material for the first substrate 20a and the second substrate 20b.

Further, in the flexible liquid crystal display 100 of the present embodiment, the first polarization film 22a and the second polarization film 22b are disposed not on outer sides of the first substrate 20a and the second substrate 20b, but rather, on the side of the liquid crystal layer 28. Such a structure is called an in-cell type liquid crystal display.

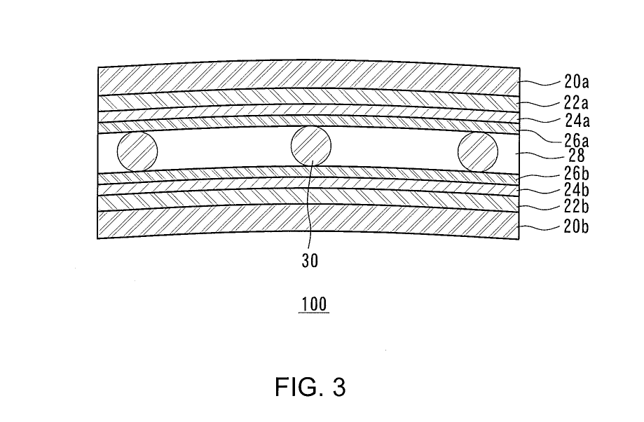

In the flexible liquid crystal display 100, even when a phase difference is caused in the light transmitting through the first substrate 20a and the second substrate 20b due to bending of the first substrate 20a and the second substrate 20b, because the light after the transmission is polarized by the first polarization film 22a and the second polarization film 22b as shown in FIG. 3, there would be no influence of the phase difference by the first substrate 20a and the second substrate 20b in relation to the first polarization film 22a, the second polarization film 22b, and the liquid crystal layer 28, and no difference in brightness/darkness is caused in the plane due to the bending.

In addition, in the in-cell type liquid crystal display such as the flexible liquid crystal display 100, after the first polarization film 22a and the second polarization film 22b are formed, the first orientation film 26a and the second orientation film 26b must be formed thereover. In this process, by applying the dye-based material for the first polarization film 22a and the second polarization film 22b, as described above, it becomes possible to prevent color changes of the first polarization film 22a and the second polarization film 22b in the heating process during the curing process of the first orientation film 26a and the second orientation film 26b.

In the present embodiment, a structure is employed in which the first polarization film 22a and the second polarization film 22b are provided on the side of the liquid crystal layer 28 both on the first substrate 20a and the second substrate 20b, but the present disclosure is not limited to such a configuration. By providing at least one of the first polarization film 22a and the second polarization film 22b on the side of the liquid crystal layer 28, the advantages of suppression of the brightness/darkness difference by the bending and suppressions of the color change of the polarization film can be realized to a certain extent.

In the present embodiment, a configuration is described in which the first substrate 20a and the second substrate 20b are flexible substrates, but the present disclosure is not limited to such a configuration. Even when a substrate which is not flexible such as a glass substrate is employed for the first substrate 20a or the second substrate 20b, the advantage of suppression of the color change of the polarization film can be realized.

Alternatively, a color filter, a black matrix, or the like may be provided on the first substrate 20a. Further, when the liquid crystal display is of the active matrix type instead of the passive matrix type, a driving element such as a TFT may be formed on the second substrate 20b.

### Example 1

An example of the flexible liquid crystal display 100 in which a glass substrate is employed for the first substrate 20a and the second substrate 20b will now be described. The formation methods for the first substrate 20a, the first polarization film 22a, the first electrode layer 24a, and the first orientation film 26a, and the formation methods for the second substrate 20b, the second polarization film 22b, the second electrode layer 24b, and the second orientation film 26b are identical to each other.

In a solution of a dye-based material, polyvinyl alcohol (PVA) having a thickness of 75 μm was stretched, to adsorb and orient the dye-based material. In a state where the first polarization film 22a thus obtained was laminated onto a carrier glass by a roll, ITO was low-temperature vapor-deposited with a film formation temperature lower than or equal to 40° C. as the first electrode layer 24a. Further, using an adhesion transfer (acryl-based adhesion agent), the film which was detached from the carrier glass was laminated with a glass substrate (soda-lime glass; thickness of 1.1 mm). With this process, a structure was obtained in the first substrate 20a in which the polyvinyl alcohol (PVA) and the glass substrate were laminated by the adhesion transfer (acryl-based adhesion agent).

Sterilization with an ultraviolet cleaning device and cleaning by alcohol were executed, and then, a light orientation film was applied over the first electrode layer 24a, and the product was baked for 1 hour at 200° C., to form the first orientation film 26a. The orientation film was applied using a spin coater and by a sequence of 10 seconds at 500 rpm, 10 seconds at 1000 rpm, and 30 seconds at 3000 rpm.

After the second substrate 20b, the second polarization film 22b, the second electrode layer 24b, and the second orientation film 26b were formed in a similar manner, the first orientation film 26a formed over the first substrate 20b and the second orientation film 26b formed over the second substrate 20b were positioned to face each other, and liquid crystal was filled in a space formed by a bead-shaped spacer 30 having a particle size of 10 μm, taking advantage of the capillary action. For the lamination, an epoxy resin was used as a sealing member.

In the completed liquid crystal cell, an AC voltage of about 10V was applied between the first electrode layer 24a and the second electrode 24b, and it was confirmed that the liquid crystal display portion was inverted from transparent to a dark color.

### Example 2

An example of the flexible liquid crystal display 100 in which the glass substrate in Example 1 is replaced with a resin substrate will now be described.

A film in which the first electrode layer 24a was formed over the first polarization film 22a manufactured by drawing polyvinyl alcohol (PVA) similar to Example 1, and a plastic film having a thickness of 80 μm and which becomes the first substrate 20a (TAC film; TD-80U manufactured by Fuji Film) were laminated to each other using a PVA-based adhesive. The plastic film and a glass plate which becomes a supporting substrate were laminated to each other on a hot plate of 50° C.˜60° C., using a heat-sensitive adhesion sheet (Intelimer Tape manufactured by Nitta Corporation).

In a state where the film and the glass supporting substrate were laminated, the surface was cleaned with alcohol, dust was blown using an air gun, and the product was cleaned with an ultraviolet irradiation device for 5 to 10 minutes. Then, similar to Example 1, the first orientation film 26a was applied and baked using the spin coater, and the polarizing ultraviolet ray was irradiated, to determine the light orientation direction. Then, the film as a whole was cooled to a temperature of lower than or equal to 10° C., and the film was detached from the glass substrate.

The bead-shaped spacer 30 was spread over the first orientation film 26a, a sealing member for sealing the liquid crystal (TB3035B manufactured by ThreeBond Corporation) was applied, and the product was laminated with the second substrate 20b, the second polarization film 22b, the second electrode layer 24b, and the second orientation film 26b which were formed in a similar manner. During the lamination, a force was equally applied using a vacuum sealing device, so that the liquid crystal cell was vacuum-packed. Then, ultraviolet rays were irradiated for 5 to 10 minutes using an ultraviolet irradiation device, to cure the sealing member.

After the sealing member inside the cell was completely cured, side surfaces of the first substrate 20a and the second substrate 20b were sealed with an epoxy resin. After the epoxy resin was completely cured, liquid crystal was filled in the cell through vacuum introduction and using a liquid crystal filler device. After the filling, the filling port for the liquid crystal was blocked with the epoxy resin, the epoxy resin was cured, and the port was sealed.

In the completed liquid crystal cell, an AC voltage of about 10V was applied between the first electrode layer 24a and the second electrode layer 24b similar to the case of Example 1, and it was confirmed that the liquid crystal display portion was inverted from transparent to the dark color.

### REFERENCE SIGNS LIST

10a FIRST RESIN SUBSTRATE; 10b SECOND RESIN SUBSTRATE; 12a FIRST POLARIZATION PLATE; 12b SECOND POLARIZATION PLATE; 14a FIRST TRANSPARENT ELECTRODE; 14b SECOND TRANSPARENT ELECTRODE; 16a FIRST ORIENTATION FILM; 16b SECOND ORIENTATION FILM; 18 LIQUID CRYSTAL LAYER; 20a FIRST SUBSTRATE; 20b SECOND SUBSTRATE; 22a FIRST POLARIZATION FILM; 22b SECOND POLARIZATION FILM; 24a FIRST ELECTRODE LAYER; 24b SECOND ELECTRODE LAYER; 26a FIRST ORIENTATION FILM; 26b SECOND ORIENTATION FILM; 28 LIQUID CRYSTAL LAYER; 30 SPACER; 100 FLEXILE LIQUID CRYSTAL DISPLAY.

1. A liquid crystal display in which a liquid crystal layer is sandwiched between two substrates, wherein
a polarization layer is formed on the side of the liquid crystal layer of at least one substrate of the substrates, and
the polarization layer includes a dye-based polarization material.

2. The liquid crystal display according to claim 1, wherein the substrate is a flexible substrate which can be deformed.

3. The liquid crystal display according to claim 1, wherein the dye-based polarization material is polyvinyl alcohol dyed with a dichroic dye.

4. The liquid crystal display according to claim 2, wherein the dye-based polarization material is polyvinyl alcohol dyed with a dichroic dye.

5. The liquid crystal display according to claim 3, wherein the polyvinyl alcohol is stretched polyvinyl alcohol.

6. The liquid crystal display according to claim 4, wherein the polyvinyl alcohol is stretched polyvinyl alcohol.
